(19) United States
(12) Patent Application Publication
(10) Pub. No.: US 2005/0259354 A1
(43) Pub. Date: Nov. 24, 2005

(54) Write head

(76) Inventors: S. N. Piramanayagam, Singapore (SG); Hee Ching Hian, Menglembu (MY)

Correspondence Address: CHRISTIE, PARKER & HALE, LLP, PO BOX 7068, PASADENA, CA, 91109-7068, US

(21) Appl. No.: 10/850,081

(22) Filed: May 19, 2004

(51) Int. Cl. G11B 5/127

(52) U.S. Cl. 360/125

(57) ABSTRACT

A write head (10) for writing information bits to magnetic storage media (40) having large magnetic anisotropy, the write head (10) comprising: a single pole-type head (20) configured to generate a magnetic field (30) perpendicular to the magnetic media (40); and a U-shaped head (21) positioned astride the single pole-type head (20) and configured to generate a fringing magnetic field (31) in the plane of the magnetic media (40); wherein the fringing field (31) induces magnetization reversal at a weaker writing field than the single pole-type head (20), and the perpendicular and fringing fields (30, 31) are applied at the same time to produce a combined field for magnetization reversal of magnetic domains in the magnetic storage media (40).

### FIELD OF THE INVENTION

This invention concerns a write head for writing information bits to magnetic storage media having large magnetic anisotropy.

### BACKGROUND OF THE INVENTION

Existing magnetic recording technology faces serious physical limitations. One such limitation is the superparamagnetic limit arising when the anisotropy energy barrier becomes so small that thermal activation energy or an applied external magnetic field can easily flip the particles away from their preferred orientation. Due to superparamagnetism, the areal density cannot increase beyond a certain limit which is dictated by the availability of high Bs (magnetic induction) writing head materials.

If the anisotropy field of a media is too high compared to the field produced by a writing head, required overwrite performance cannot be obtained. To overcome this problem, heat-assisted magnetic recording (HAMR) is proposed by the prior art. Heat-assisted magnetic recording has major challenges including the requirements of a stable lubricant, stable head-disk interface, and the focusing of light onto dots smaller than 30 nm (beyond diffraction limits), and the integration of a light source with a flying head.

### SUMMARY OF THE INVENTION

In a first aspect, there is provided a write head for writing information bits to magnetic storage media having large magnetic anisotropy. The write head includes a single pole-type head to produce a magnetic field perpendicular to the magnetic media and a U-shaped head positioned astride the single pole-type head to produce a fringing magnetic field in the plane of the magnetic media. In addition, the fringing field induces magnetization reversal at a weaker writing field than the single pole-type head, and the perpendicular and fringing fields are applied at the same time to produce a combined field for magnetization reversal of magnetic domains in the magnetic storage media.

The fringing field and perpendicular field may be orthogonal to each other.

The ends of the heads may be co-planar to each other. The ends of the heads may be co-planar to the Air Bearing Surface (ABS).

The coercivity of the magnetic storage media may decrease as the strength of the fringing field for inducing magnetization reversal is increased.

The fringing field may be applied in the cross-track direction

In a second aspect, there is provided a write head for writing information bits to magnetic storage media having large magnetic anisotropy. The write head including a single pole-type head to produce a magnetic field perpendicular to the magnetic media and a U-shaped head positioned astride the single pole-type head to produce a fringing magnetic field in the plane of the magnetic media. In addition, the perpendicular field induces magnetization reversal at a weaker writing field than the U-shaped head, and the perpendicular and fringing fields are applied at the same time to produce a combined field for magnetization reversal of magnetic domains in the magnetic storage media.

The coercivity of the magnetic storage media may decrease as the strength of the perpendicular field for inducing magnetization reversal is increased.

In a third aspect, there is provided a method for writing information bits to magnetic storage media. The method involving applying a magnetic field perpendicular to the magnetic media and applying a fringing magnetic field in the plane of the magnetic media. In addition, the fringing field induces magnetization reversal at a weaker writing field, and the perpendicular and fringing fields are applied at the same time to produce a combined field for magnetization reversal of magnetic domains in the magnetic storage media.

The coercivity of the magnetic storage media may decrease as the strength of the fringing field for inducing magnetization reversal is increased.

In a fourth aspect, there is provided a method for writing information bits to magnetic storage media. The method involving applying a magnetic field perpendicular to the magnetic media and applying a fringing magnetic field in the plane of the magnetic media. In addition, the perpendicular field induces magnetization reversal at a weaker writing field, and the perpendicular and fringing fields are applied at the same time to produce a combined field for magnetization reversal of magnetic domains in the magnetic storage media.

The coercivity of the magnetic storage media may decrease as the strength of the perpendicular field for inducing magnetization reversal is increased.

In a fifth aspect, there is provided a data storage device for storing information bits. The device including a motor for rotating a magnetic storage medium and an arm for positioning a write head adjacent to a surface of the magnetic storage medium. In addition, the write head includes a single pole-type head to produce a magnetic field perpendicular to the magnetic media, and a U-shaped head positioned astride the single pole-type head to produce a fringing magnetic field in the plane of the magnetic media and the fringing field induces magnetization reversal at a weaker writing field than the single pole-type head, and the perpendicular and fringing fields are applied at the same time to produce a combined field for magnetization reversal of magnetic domains in the magnetic storage media.

The coercivity of the magnetic storage media may decrease as the strength of the fringing field for inducing magnetization reversal is increased.

In a sixth aspect, there is provided a data storage device for storing information bits. The device including a motor for rotating a magnetic storage medium and an arm for positioning a write head adjacent to a surface of the magnetic storage medium. In addition, the write head includes a single pole-type head to produce a magnetic field perpendicular to the magnetic media, and a U-shaped head positioned astride the single pole-type head to produce a fringing magnetic field in the plane of the magnetic media and the perpendicular field induces magnetization reversal at a weaker writing field than the U-shaped head, and the perpendicular and fringing fields are applied at the same time to produce a combined field for magnetization reversal of magnetic domains in the magnetic storage media.

The coercivity of the magnetic storage media may decrease as the strength of the perpendicular field for inducing magnetization reversal is increased.

### BRIEF DESCRIPTION OF THE DRAWINGS

Embodiments of the invention will now be described with reference to the accompanying drawings, in which:

FIG. 1 is a perspective plan view of the writing head;

FIG. 2 is a perspective plan view of the writing head of FIG. 1, rotated 90; clockwise;

FIG. 3 is a front view of the writing head of FIG. 1;

FIG. 4 is a graph of the hysteresis loops of a perpendicular recording medium as a function of the additional field in the longitudinal direction;

FIG. 5 is a graph of the coercivity of a perpendicular recording medium plotted as a function of the additional field in the longitudinal direction; and

FIG. 6 is a pictorial representation of a disc drive that can use writing heads constructed in accordance with the invention.

### DETAILED DESCRIPTION OF THE INVENTION

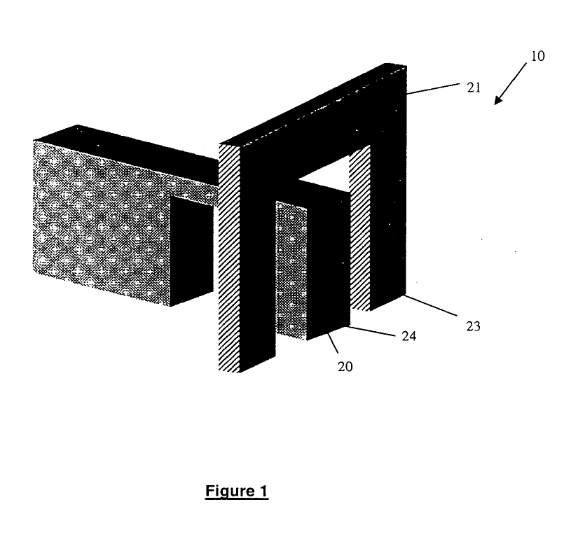

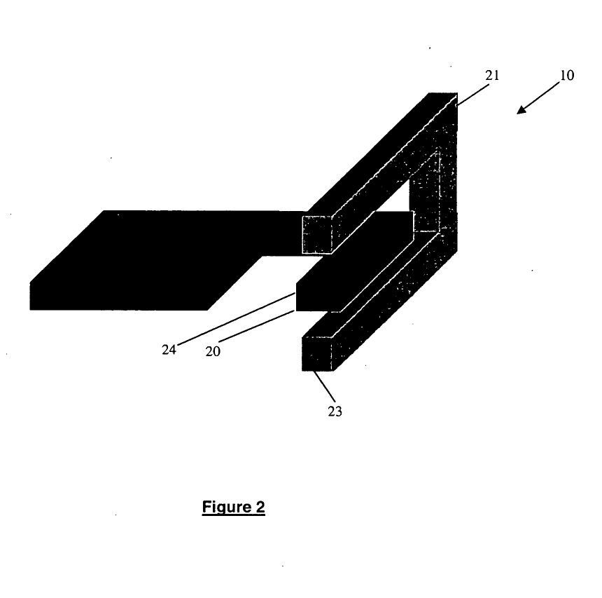

Referring to FIGS. 1 and 2, a magnetic write head 10 is provided for tilted magnetic recording to magnetic storage media 40 such as a magnetic disc. The write head 10 comprises a single pole-type head 20 and a U-shaped head 21 positioned astride the single pole-type head 20. The single pole-type head 20 is a term familiar to those in the magnetic recording industry for describing a magnetic head used for perpendicular recording. The ends 23, 24 of the single pole-type head 20, and the U-shaped head 21 are preferably co-planar. More preferably, the ends 23, 24 of the heads 20, 21 are co-planar with the Air Bearing Surface (ABS) 41 which exists between the write head 10 and the magnetic media 40.

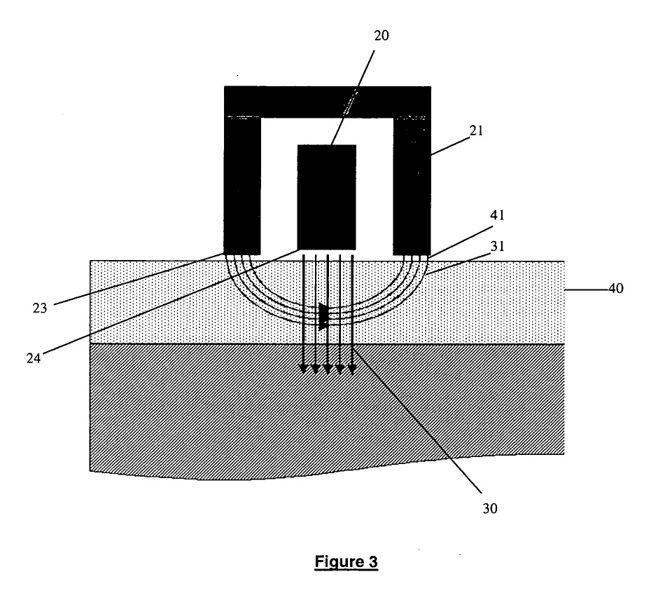

Referring to FIG. 3, during a write procedure, the single pole-type head 20 produces a vertical magnetic field 30 perpendicular to the magnetic media 40 for reversing the magnetization reversal of magnetic domains in the magnetic storage media 40. The U-shaped head 21 produces an additional field 31, which is a fringing magnetic field between the two ends 23 of the U-shaped head 21 in the plane of the magnetic media 40. The additional field 31 induces magnetization reversal at a weaker writing field than the single pole-type head 20. The perpendicular and fringing fields 30, 31 are applied at the same time to produce a combined field for magnetization reversal of magnetic domains in the magnetic storage media 40 at a lower writing field.

For magnetization reversal to occur, the writing field bubble has to be greater than the dynamic coercivity of the media 40. Applying the additional field 31 perpendicular to the direction in which the single pole-type head 20 is magnetized for achieving optimum magnetic properties (this direction is also known as the easy axis or angle of inclination), can cause the magnetization reversal to occur at field values much smaller than the coercivity.

In perpendicular recording, the additional field 31 is a field in the film-plane, applied parallel to the plane of the media 40, preferably in the cross-track direction (transverse to the track direction of the media 40). That is, in addition to the writing field 30, an additional magnetic field 31 is applied in a direction perpendicular to the easy axis of magnetization. Due to the additional field 31 being applied, magnetization reverses at a lower writing field.

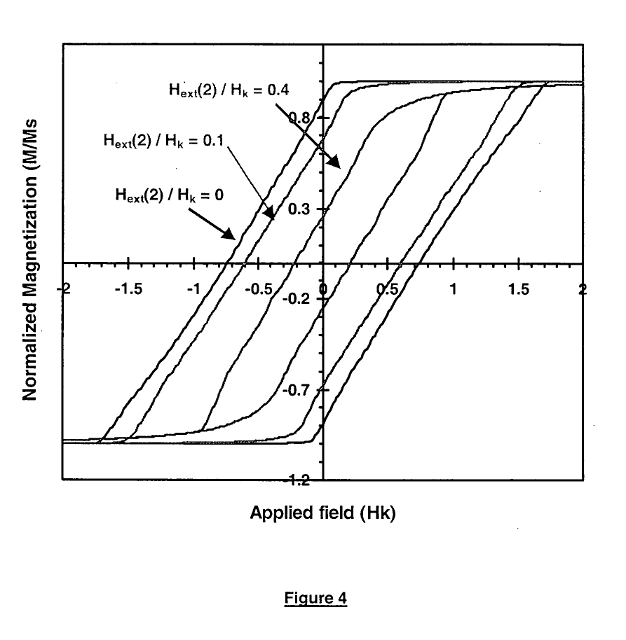

FIG. 4 depicts the hysteresis loops of a perpendicular recording medium 40, as a function of the additional field 31 in the longitudinal direction. The hysteresis loop of a perpendicular recording medium 40 is simulated as a function of the additional writing field 31. The coercivity of the medium 40 decreases as the strength of the additional writing field 31 is increased.

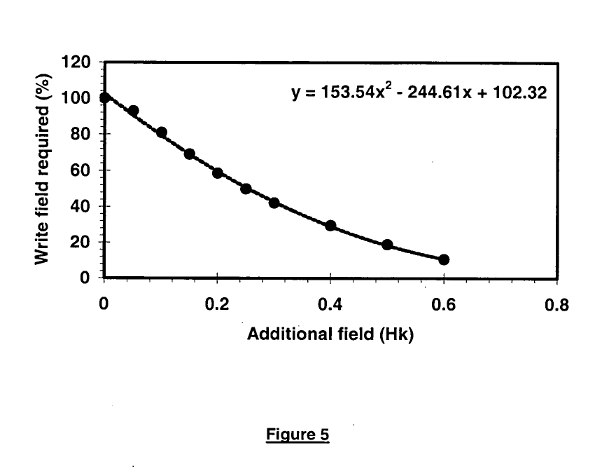

FIG. 5 depicts a write field 30 required to reverse 50% of the grains of a perpendicular recording medium 40, as a function of the additional field 31 in the longitudinal direction. The coercivity of a perpendicular recording medium 40 plotted as a function of the additional field 31. For an additional field 31 as low as 0.2 Hk, the required writing field 30 is reduced by 60%.

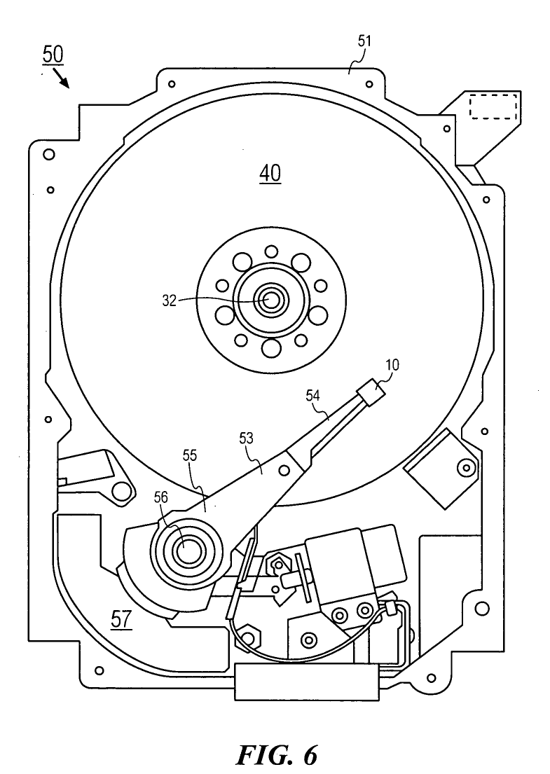

Referring to FIG. 6, the write head 10 is provided in a data storage device such as a hard disk drive 50. The disc drive 50 includes a housing 51 to contain the components of the disc drive 50. A spindle motor 52 is provided for rotating one or more magnetic media 40. At least one arm 53 is contained within the housing 51, each arm 53 having a first end 54 with a recording and/or reading head or slider 10. A second end 55 of the arm 53 is pivotally mounted on a shaft by a bearing 56. An actuator motor 57 is located on the arm's second end 55, for pivoting the arm 53 to position the head 10 over a desired sector of the disc 40. The actuator motor 57 is regulated by a controller (not shown).

Advantageously, the write head 10 potentially enhances the data storage density to values beyond that of the conventional heads. Using the write head 10, it is possible to eliminate the use of heat assisted magnetic recording (HAMR). Also, the present invention allows the use of high Ku materials for recording media, and therefore extends the limit of magnetic recording. Further, the writing field as well as the writing time is improved.

Although the invention has been described with reference to perpendicular recording, longitudinal recording is possible. The write head 10 configuration is the same for both perpendicular and longitudinal recording. However, in contrast to perpendicular recording, the additional field comes from single pole-type head 20 which produces a perpendicular field. The additional field is a field perpendicular to the film-plane produced by the U-shaped head 21. The additional field is applied perpendicular to the plane of the media 40.

It will be appreciated by a person of ordinary skill in the art that numerous variations and/or modifications may be made to the invention as shown in the specific embodiments without departing from the scope or spirit of the invention as broadly described. The present embodiments are, therefore, to be considered in all respects illustrative and not restrictive.

1. A write head configured to write information bits to magnetic storage media having large magnetic anisotropy, the write head comprising:
a single pole-type head configured to generate a magnetic field perpendicular to the magnetic media; and
a U-shaped head positioned astride the single pole-type head and configured to generate a fringing magnetic field in the plane of the magnetic media;
wherein the fringing field induces magnetization reversal at a weaker writing field than the single pole-type head, and the perpendicular and fringing fields are applied at the same time to produce a combined field for magnetization reversal of magnetic domains in the magnetic storage media.

2. The write head according to claim 1, wherein the fringing field and perpendicular field are orthogonal to each other.

3. The write head according to claim 1, wherein the ends of the heads are co-planar to each other.

4. The write head according to claim 3, wherein the ends of the heads are co-planar to the Air Bearing Surface (ABS).

5. The write head according to claim 1, wherein the coercivity of the magnetic storage media decreases as the strength of the fringing field for inducing magnetization reversal is increased.

6. The write head according to claim 1, wherein the fringing field is applied in the cross-track direction.

7. A write head configured to write information bits to magnetic storage media having large magnetic anisotropy, the write head comprising:
a single pole-type head configured to generate a magnetic field perpendicular to the magnetic media; and
a U-shaped head positioned astride the single pole-type head and configured to generate a fringing magnetic field in the plane of the magnetic media;
wherein the perpendicular field induces magnetization reversal at a weaker writing field than the U-shaped head, and the perpendicular and fringing fields are applied at the same time to produce a combined field for magnetization reversal of magnetic domains in the magnetic storage media.

8. The write head according to claim 7, wherein the fringing field and perpendicular field are orthogonal to each other.

9. The write head according to claim 7, wherein the ends of the heads are co-planar to each other.

10. The write head according to claim 9, wherein the ends of the heads are co-planar to the Air Bearing Surface (ABS).

11. The write head according to claim 7, wherein the coercivity of the magnetic storage media decreases as the strength of the perpendicular field for inducing magnetization reversal is increased.

12. The write head according to claim 7, wherein the fringing field is applied in the cross-track direction.

13. A method for writing information bits to magnetic storage media, the method comprising:
applying a magnetic field perpendicular to the magnetic media; and
applying a fringing magnetic field in the plane of the magnetic media;
wherein the fringing field induces magnetization reversal at a weaker writing field, and the perpendicular and fringing fields are applied at the same time to produce a combined field for magnetization reversal of magnetic domains in the magnetic storage media.

14. The method according to claim 13, wherein the fringing field and perpendicular field are orthogonal to each other.

15. The method according to claim 13, wherein the ends of the heads are co-planar to each other.

16. The method according to claim 15, wherein the ends of the heads are co-planar to the Air Bearing Surface (ABS).

17. The method according to claim 13, wherein the coercivity of the magnetic storage media decreases as the strength of the fringing field for inducing magnetization reversal is increased.

18. The method according to claim 13, wherein the fringing field is applied in the cross-track direction.

19. A method for writing information bits to magnetic storage media, the method comprising:
applying a magnetic field perpendicular to the magnetic media; and
applying a fringing magnetic field in the plane of the magnetic media;
wherein the perpendicular field induces magnetization reversal at a weaker writing field, and the perpendicular and fringing fields are applied at the same time to produce a combined field for magnetization reversal of magnetic domains in the magnetic storage media.

20. The method according to claim 19, wherein the fringing field and perpendicular field are orthogonal to each other.

21. The method according to claim 19, wherein the ends of the heads are co-planar to each other.

22. The method according to claim 21, wherein the ends of the heads are co-planar to the Air Bearing Surface (ABS).

23. The method according to claim 19, wherein the coercivity of the magnetic storage media decreases as the strength of the perpendicular field for inducing magnetization reversal is increased.

24. The method according to claim 19, wherein the fringing field is applied in the cross-track direction.

25. A data storage device for storing information bits, the device comprising:
a motor configured to rotate a magnetic storage medium; and
an arm configured to position a write head adjacent to a surface of the magnetic storage medium;
wherein the write head includes a single pole-type head configured to generate a magnetic field perpendicular to the magnetic media, and a U-shaped head positioned astride the single pole-type head and configured to generate a fringing magnetic field in the plane of the magnetic media; and
wherein the fringing field induces magnetization reversal at a weaker writing field than the single pole-type head, and the perpendicular and fringing fields are applied at the same time to produce a combined field for magnetization reversal of magnetic domains in the magnetic storage media.

26. The device according to claim 25, wherein the fringing field and perpendicular field are orthogonal to each other.

27. The device according to claim 25, wherein the ends of the heads are co-planar to each other.

28. The device according to claim 27, wherein the ends of the heads are co-planar to the Air Bearing Surface (ABS).

29. The device according to claim 25, wherein the coercivity of the magnetic storage media decreases as the strength of the fringing field for inducing magnetization reversal is increased.

30. The device according to claim 25, wherein the fringing field is applied in the cross-track direction.

31. The device according to claim 25, wherein the data storage device is a hard drive.

32. A data storage device for storing information bits, the device comprising:
a motor configured to rotate a magnetic storage medium; and
an arm configured to position a write head adjacent to a surface of the magnetic storage medium;
wherein the write head includes a single pole-type head configured to generate a magnetic field perpendicular to the magnetic media, and a U-shaped head positioned astride the single pole-type head and configured to generate a fringing magnetic field in the plane of the magnetic media; and
wherein the perpendicular field induces magnetization reversal at a weaker writing field than the U-shaped head, and the perpendicular and fringing fields are applied at the same time to produce a combined field for magnetization reversal of magnetic domains in the magnetic storage media.

33. The device according to claim 32, wherein the fringing field and perpendicular field are orthogonal to each other.

34. The device according to claim 32, wherein the ends of the heads are co-planar to each other.

35. The device according to claim 34, wherein the ends of the heads are co-planar to the Air Bearing Surface (ABS).

36. The device according to claim 32, wherein the coercivity of the magnetic storage media decreases as the strength of the perpendicular field for inducing magnetization reversal is increased.

37. The device according to claim 32, wherein the fringing field is applied in the cross-track direction.

38. The device according to claim 32, wherein the data storage device is a hard drive.
